(19) United States
(12) Patent Application Publication
(10) Pub. No.: US 2019/0178642 A1
(43) Pub. Date: Jun. 13, 2019

(54) METHOD FOR SHAPE ERROR IN-SITU MEASUREMENT OF TORUSES

(71) Applicant: Dalian University of Technology, Dalian City, Liaoning Province (CN)

(72) Inventors: Qingchao SUN, Dalian City, Liaoning Province (CN); Xin LIU, Dalian City, Liaoning Province (CN); Jue WANG, Dalian City, Liaoning Province (CN); Wei SUN, Dalian City, Liaoning Province (CN); Yingjie JIANG, Dalian City, Liaoning Province (CN); Jiaqi SUO, Dalian City, Liaoning Province (CN)

(21) Appl. No.: 16/321,991

(22) PCT Filed: May 3, 2017
(86) PCT No.: PCT/CN2017/082893

§ 371 Date: Jan. 30, 2019

(51) Int. Cl. G01B 21/30; G01B 7/34; G01B 5/28

(52) U.S. Cl. CPC G01B 21/30; G01B 5/285; G01B 7/345

(57) ABSTRACT

The present invention provides a method for shape error in-situ measurement of toruses, and is realized based on a system for shape error in-situ measurement of large-scale toruses. The system for in-situ measurement comprises an attitude adjusting part, a rotating part and a measuring part. The attitude adjusting part comprises an attitude adjusting platform, an attitude adjusting platform motor and an adapter panel; the rotating part comprises a rotating index plate base and a high-precision rotating index plate; and the measuring part comprises a sensor clamp, sensor holders, contact sensors and associated equipment. The present invention realizes the application of the three-point method in shape error measurement of the torus, also realizes algorithm improvement of the three-point method in realizing shape error in-situ measurement of the torus, can realize shape error in-situ measurement of the torus, can greatly reduce the processing time of the part and can reduce the influence of repeated clamping on part precision.

### TECHNICAL FIELD

The present invention belongs to a method for flatness error in-situ measurement, and can be widely applied to flatness measurement of torus parts of major engineering equipment such as aircraft engines, centrifugal compressors and the like.

### BACKGROUND

The shape error of an assembly interface is very important in the assembly of mechanical parts, and the shape error often affects the contact stiffness and assembly precision. In order to control the assembly performance accurately, it is necessary to test the shape error of the parts. At present, a lot of major equipment in China has large-scale toruses. For example, high-pressure and low-pressure turbine shafts, disc drums of high-pressure compressors, etc. in aircraft engines have a large number of toruses. The assembly problem of these high-precision parts has a quite close detecting relationship with the shape error, while in the assembly process, the workpiece often cannot be rotated freely. Thus, in view of the assembly problem of these high-precision parts, in-situ measurement is very important.

A successive two-point method is an important method applied to error measurement of straightness. Through treatment of multiple columns of test data, the flatness error of a rectangular plane can be obtained, but the treatment algorithm can eliminate the unevenness error of the measuring head of the sensor and cannot separate a bracket corner error in the installation process of the sensor. Meanwhile, it is difficult to apply to the detection of the flatness error of a narrow torus. A three-point method is the extension of the successive two-point method. When the torus is used as a measuring object for detecting the flatness error, because the three-point method can separate the initial alignment error, the three-point method has high measurement precision, but cannot be applied to in-situ measurement. Namely, in the measurement process, the sensor is fixed and the workpiece is rotated, which is not suitable for form and position tolerance measurement in the assembly process.

The present invention proposes a method for in-situ measurement based on the three-point method. The method can realize flatness error measurement of large-scale toruses in the assembly process, can effectively eliminate the impact of zero error through the algorithm, and has important practical significance.

### SUMMARY

With respect to the problem of part assembly of a large torus in the aircraft engines, the present invention proposes a method for flatness error in-situ measurement of toruses by combining engineering practice based on the basic principle of measurement of the toruses of three-point method.

The method has the following technical solution:

A system for flatness in-situ measurement of torus is applied to a flatness measurement instrument of end surfaces of an aviation engine shaft disc and a conical wall and comprises an attitude adjusting part, a rotating part and a measuring part.

The attitude adjusting part comprises an attitude adjusting platform 5, an attitude adjusting platform motor 4 and an adapter panel 6; the attitude adjusting platform 5 is used for adjusting the rotation angles along z-axis and x-axis and is controlled by the attitude adjusting platform motor 4, and the attitude adjusting platform motor 4 is controlled by a controller; z-axis is the axis perpendicular to the plane of the attitude adjusting platform 5, and the angle adjusted is from 0° to 360°; x-axis is the axis perpendicular to the axis of the attitude adjusting platform motor 4, and the angle adjusted is from −30° to 30°; and the lower surface of the adapter panel 6 is connected to the top surface of the attitude adjusting platform 5, and the upper surface of the adapter panel 6 is connected to a rotating index plate base 7.

The rotating part comprises the rotating index plate base 7 and a rotating index plate 1; the main body of the rotating index plate base 7 is of a cubic frame structure with T-grooves in two side surfaces and bottom surface, and the T-grooves are connected with the adapter panel 6 by mating bolts and nuts; a gear on the rotating index plate 1 is engaged with a gear on the rotating index plate base 7; the top surface of the rotating index plate base 7 is provided with a lever, and the rotating index plate 1 can be driven to move forward by moving the lever forward to make the gear on the rotating index plate 1 engage with the gear on the rotating index plate base 7, can be rotated manually for a required angle, and then stuck and fixed again by restoring the lever to make the gear on the rotating index plate 1 disengage with the gear on the rotating index plate base 7.

The minimum rotation angle of the rotating index plate 1 is 1°, the rotation precision is 10″, and the top surface of the rotating index plate 1 has a T-groove and a central hole; one side of the rotating index plate 1 is positioned with a mandrel of a sensor clamp 10 through the central hole and fixed by the T-groove and mating bolt and nut 2, and the other side is engaged with the gear on the rotating index plate base 7 through a gear.

The measuring part comprises the sensor clamp 10, sensor holders 9, contact sensors 8; the sensor clamp 10 is of a disk structure and has four groups of sensor jacks in total, two groups are single-row sensor jacks with three jacks in each group, and the other two groups are double-row sensor jacks with three jacks in each row and six jacks in each group; the position of the central jack in each row of sensor jacks is set to 0°, 90°, 180° and 270° respectively, and the angle between the central jack and the sensor jacks on both sides of the central jack is 10°; in each row, all the sensor jacks have equal distances to the disk center, but different rows have different distances to the disk center, and the distances from the sensor jacks to the disk center of the sensor clamp 10 is from 100 mm to 300 mm; the single-row sensor jacks are used for measuring the shape error of a flange surface on the centerline of the jacks, and the double-row sensor jacks are used for measuring the shape error on two axial sides of the jacks; a sensor holder 9 is installed in each sensor jack and used for fixing each contact sensor 8; and data measured by the contact sensors 8 is transmitted to the upper computer through an RS232 bus, and a Labview program is written in the upper computer to read and analyze the data.

Since in-situ measurement needs to be realized, i.e., the workpiece is immovable and a measuring instrument rotates, the coaxiality between the measuring instrument and the torus greatly influences a measured value. The device can realize leveling of the coaxiality to greatly enhance the reliability of flatness in-situ measurement of the torus.

The present invention has the beneficial effects: the present invention realizes the application of the three-point method in shape error measurement of the torus, also realizes algorithm improvement of the three-point method in realizing shape error in-situ measurement of the torus, can realize shape error in-situ measurement of the torus, can greatly reduce the processing time of the part and can reduce the influence of repeated clamping on part precision.

### DESCRIPTION OF DRAWINGS

FIG. 1 is a structural schematic diagram of the present invention.

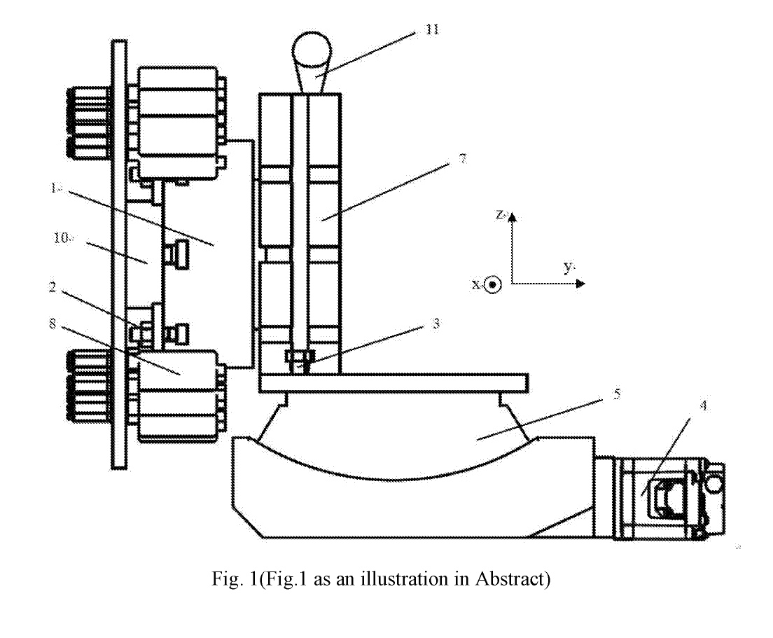

FIG. 2 is a schematic diagram of sensor leveling.

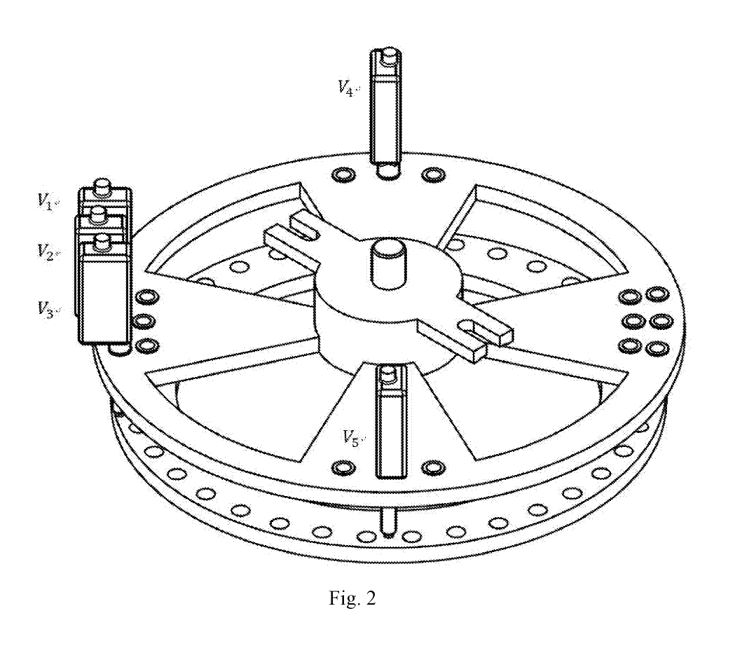

FIG. 3 is a schematic diagram of a measurement error.

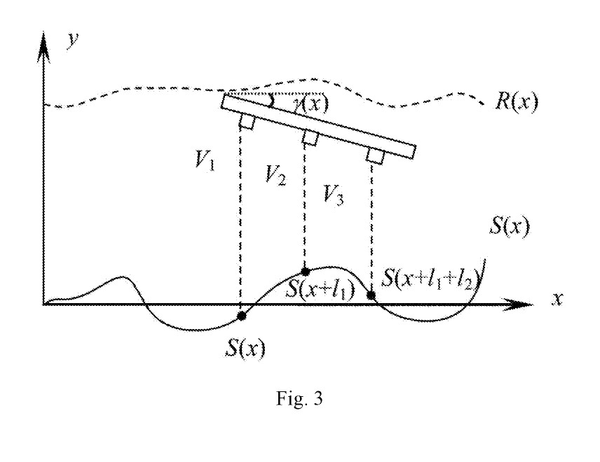

In the figures: 1 rotating index plate; 2 bolt and nut; 3 T-shaped bolt and nut; 4 attitude adjusting platform motor; 5 attitude adjusting platform; 6 adapter panel; 7 rotating index plate base; 8 contact sensor; 9 sensor holder; 10 sensor clamp; and 11 lever.

### DETAILED DESCRIPTION

Specific embodiment of the present invention is further described below in combination with accompanying drawings and the technical solution.

### Embodiments

A method for shape error in-situ measurement of toruses comprises the following steps:

step A: at least installing five contact sensors 8 on a sensor clamp 10, wherein three contact sensors 8V₁, V₂ and V₃ are sensors for measurement, can be installed in any row of jack in any group, but must be installed in the same row; the fourth contact sensor 8V₄ is installed in the jack which has an angle of 90° with V₂, and is located in the central jack; the fifth contact sensor 8V₅ is installed in the jack which has an angle of 90° with V₂, is located in the central jack and is symmetrical with V₄, wherein the central angle between V₁ and V₂ is α₁, the central angle between V₂ and V₃ is α₂, α₁=α₂=α,

$$α = \frac{{360}^{∘}}{N}$$

and N is the quantity of measurement points on a to-be-measured piece;

step B: setting an inclined angle between the to-be-measured piece and an axis of a disc of the sensor clamp 10 as θ, setting the corner in each measurement as a and setting the distances from three contact sensors 8V₁, V₂ and V₃ in y-axis direction to the to-be-measured piece as d₁, d₂ and d₃; because an installation error is difficult to be completely leveled, there are unevenness errors δ₁=d₂−d₁ and δ₂=d₃−d₁; for the kth measurement point:

δ′₁=δ₁+Rθ{cos(kα)−cos[(k+1)α]} (1)

δ′₂=δ₂+Rθ{cos(kα)−cos[(k+2)α]} (2)

the above formulas show that: during in-situ measurement of the workpiece, the zero errors δ′₁and δ′₂are not constant values, and are functions of the corner α, but we can realize δ₁>>Rθ through the leveling process, so approximately: δ′₁=δ₁ and δ′₂=δ₂;

leveling treatment is conducted on measuring heads of three contact sensors 8V₂, V₄ and V₅; leveling is realized by an attitude adjusting platform 5; the attitude adjusting platform 5 has two freedoms; and an attitude adjusting platform motor 4 can be used to adjust rotation in x-axis direction and z-axis direction; the rotation in the z-axis direction is firstly adjusted so that the readings of two sensors are identical, and then the rotation in the x-axis direction is adjusted so that the reading of V₂ is the same as the readings of V₄ and V₅;

step C: determining a basal plane for V₂, V₄ and V₅ after leveling operation, wherein there may be a certain sensor installation error between two contact sensors 8 V₁ and V₃ and the basal plane in y-axis direction, and the error can be reduced as much as possible by repeatedly adjusting the sensor clamp 10; the installation errors δ₁ and δ₂ are difficult to be completely leveled; and leveling can only reduce δ₁ and δ₂ as much as possible;

step D: reading the values of V₁, V₂ and V₃ and recording the first group of readings after completing step B and step C; rotating the rotating index plate 1 by moving the lever 11 forward; then rotating the rotating index plate 1 clockwise or anticlockwise with the corner α; fixing the rotating index plate 1 by moving the lever 11 backward; recording the second group of readings and so on to read N groups of readings;

setting S(k) as a component of the flatness error of the kth measurement point of the to-be-measured point in the y-axis direction, setting R(k) as a component of the kth measurement point of the sensor clamp 10 in the y-axis direction and setting tan γ(k) as an angle caused by the flatness error of the sensor clamp, wherein V₁(k), V₂(k) and V₃(k) are respectively the same group of measured values of sensors V₁, V₂ and V₃ and Δl is a spacing between two adjacent measurement points, and then:

V₁(k)=S(k)+R(k) (3)

V₂(k)=S(k+1)+R(k)+Δl tan γ(k) (4)

V₃(k)=S(k+2)+R(k)+2Δl tan γ(k) (5)

setting R(1)=0, then S(1)=V₁(1) and S(2)=V₂(1), so as to compute a recurrence formula:

S(k+2)=V(k)−2V₂(k)+V₃(k)−S(k)+2S(k+1) (6)

when considering the unevenness error caused by installation, then:

V₁(k)=S(k)+R(k) (7)

V₂(k)=S(k+Δl)+R(k)+Δl tan γ(k)+δ₁ (8)

V₃(k)=S(k+2Δl)+R(k)+2Δl tan γ(k)+δ₂ (9)

through an inductive method, the error term of S(k+2) is:

Δs(k+2)=−(k−1)(k+1)δ₁+½k(k+1)δ₂, k=1,2, . . . ,N (10)

step E: continuing to rotate the rotating index plate 1 after reading N groups of readings, and reading the (N+1)th group of data and the (N+2)th group of data to eliminate an initial error, wherein because the measured surface is a ring and

$$N = \frac{{360}^{∘}}{α} ,$$

the (N+1)th point coincides with the 1st point and the (N+2)th point coincides with the 2nd point; setting

a=S(N+2)−S(2), b=S(N+1)−S(1), (11)

computing the values of δ₁ and δ₂ as:

$${δ}_{1} = \frac{( N + 1 ) b - ( N - 1 ) a}{{N}^{2} + 1} , \\ {δ}_{2} = \frac{4 - 2 N}{{N}^{2} + 1} a + \frac{2 ( {N}^{2} + N - 1 ) b}{{N}^{3} + N} \qquad ( 12 )$$

computing and substituting δ₁ and δ₂ into formula (6) to obtain the value Δs(k+2) of the error term of S(k+2), so an error separation formula is:

S̅(k+2)=S(k+2)−Δs(k+2) (k=1,2, . . . ,N) (13).

We claims:

1. A method for shape error in-situ measurement of toruses, the method for shape error in-situ measurement of toruses executing in-situ measurement using a system for flatness in-situ measurement of toruses, wherein
the system for flatness on-line measurement of torus comprises an attitude adjusting part, a rotating part and a measuring part;
the attitude adjusting part comprises an attitude adjusting platform (5), an attitude adjusting platform motor (4) and an adapter panel (6); the attitude adjusting platform (5) is used for adjusting the rotation angles along z-axis and x-axis and is controlled by the attitude adjusting platform motor (4), and the attitude adjusting platform motor (4) is controlled by a controller; z-axis is the axis perpendicular to the plane of the attitude adjusting platform (5), and the angle adjusted is from 0° to 360°; x-axis is the axis perpendicular to the axis of the attitude adjusting platform motor (4), and the angle adjusted is from −30° to 30°; the lower surface of the adapter panel (6) is connected to the upper surface of the attitude adjusting platform (5), and the top surface of the adapter panel (6) is connected to a rotating index plate base (7);
the rotating part comprises the rotating index plate base (7) and a rotating index plate (1); the main body of the rotating index plate base (7) is of a cubic frame structure with T-grooves in two side surfaces and bottom surface, and the T-grooves are connected with the adapter panel (6) by mating bolts and nuts; a gear on the rotating index plate (1) is engaged with a gear on the rotating index plate base (7); the top surface of the rotating index plate base (7) is provided with a lever, and the rotating index plate (1) can be driven to move forward by moving the lever forward to make the gear on the rotating index plate (1) engage with the gear on the rotating index plate base (7), can be rotated manually for a required angle, and then stuck and fixed again by restoring the lever to make the gear on the rotating index plate (1) disengage with the gear on the rotating index plate base (7);
the minimum rotation angle of the rotating index plate (1) is 1°, the rotation precision is 10″, and the top surface of the rotating index plate (1) has a T-groove and a central hole; one side of the rotating index plate (1) is positioned with a mandrel of a sensor clamp (10) through the central hole and fixed by the T-groove and mating bolt and nut (2), and the other side is engaged with the gear on the rotating index plate base (7) through a gear;
the measuring part comprises the sensor clamp (10), sensor holders (9), contact sensors (8); the sensor clamp (10) is of a disk structure and has four groups of sensor jacks in total, two groups are single-row sensor jacks with three jacks in each group, and the other two groups are double-row sensor jacks with three jacks in each row and six jacks in each group; the position of the central jack in each row of sensor jacks is set to 0°, 90°, 180° and 270° respectively, and the angle between the central jack and the sensor jacks on both sides of the central jack is 10°; in each row, all the sensor jacks have equal distances to the disk center, but different rows have different distances to the disk center, and the distances from the sensor jacks to the disk center of the sensor clamp (10) is from 100 mm to 300 mm; the single-row sensor jacks are used for measuring the flatness of a flange surface on the centerline of the jacks, and the double-row sensor jacks are used for measuring the flatness on two axial sides of the jacks; a sensor holder (9) is installed in each sensor jack and used for fixing each contact sensor (8); and data measured by the contact sensors (8) is transmitted to the upper computer through an RS232 bus, and a Labview program is written in the upper computer to read and analyze the data;
steps are as follows:
step A: at least installing five contact sensors (8) on a sensor clamp (10), wherein three contact sensors (8) V₁, V₂ and V₃ are sensors for measurement, can be installed in any row of jack in any group, but must be installed in the same row; the fourth contact sensor (8) V₄ is installed in the jack which has an angle of 90° with V₂, and is located in the central jack; the fifth contact sensor (8) V₅ is installed in the jack which has an angle of 90° with V₂, is located in the central jack and is symmetrical with V₄, wherein the central angle between V₁ and V₂ is α₁, the central angle between V₂ and V₃ is α₂, α₁=α₂=α,
$$α = \frac{{360}^{∘}}{N}$$
and N is the quantity of measurement points on a to-be-measured piece;
step B: setting an inclined angle between the to-be-measured piece and an axis of a disc of the sensor clamp (10) as θ, setting the corner in each measurement as a and setting the distances from three contact sensors (8) V₁, V₂ and V₃ in y-axis direction to the to-be-measured piece as d₁, d₂ and d₃; because an installation error is difficult to be completely leveled, there are unevenness errors δ₁=d₂−d₁ and δ₂=d₃−d₁; for the kth measurement point:
δ′₁=δ₁+Rθ{cos(kα)−cos[(k+1)α]} (1)
δ′₂=δ₂+Rθ{cos(kα)−cos[(k+2)α]} (2)
the above formulas show that: during in-situ measurement of the to-be-measured workpiece, the zero errors δ′₁and δ′₂are not constant values, and are functions of the corner α, but δ₁>>Rθ is realized through the leveling process, so: δ′₁=δ₁ and δ′₂=δ₂;
leveling treatment is conducted on measuring heads of three contact sensors (8) V₂, V₄ and V₅; leveling is realized by an attitude adjusting platform (5); the attitude adjusting platform (5) has two freedoms; and an attitude adjusting platform motor (4) can be used to adjust rotation in x-axis direction and z-axis direction; the rotation in the z-axis direction is firstly adjusted so that the readings of two sensors are identical, and then the rotation in the x-axis direction is adjusted so that the reading of V₂ is the same as the readings of V₄ and V₅;
step C: determining a basal plane for V₂, V₄ and V₅ after leveling operation, wherein there may be an installation error between two contact sensors (8) V₁ and V₃ and the basal plane in y-axis direction, and the error can be reduced as much as possible by repeatedly adjusting the sensor clamp (10); and leveling can reduce δ₁ and δ₂ as much as possible;
step D: reading the values of V₁, V₂ and V₃ and recording the first group of readings after completing step B and step C; rotating the rotating index plate (1) by moving the lever (11) forward; then rotating the rotating index plate (1) clockwise or anticlockwise with the corner α; fixing the rotating index plate (1) by moving the lever (11) backward; recording the second group of readings and so on to read N groups of readings;
setting S(k) as a component of the flatness error of the kth measurement point of the to-be-measured point in the y-axis direction, setting R(k) as a component of the kth measurement point of the sensor clamp (10) in the y-axis direction and setting tan γ(k) as an angle caused by the flatness error of the sensor clamp, wherein V₁(k), V₂(k) and V₃(k) are respectively the same group of measured values of sensors V₁, V₂ and V₃ and Δl is a spacing between two adjacent measurement points, and then:
V₁(k)=S(k)+R(k) (3)
V₂(k)=S(k+1)+R(k)+Δl tan γ(k) (4)
V₃(k)=S(k+2)+R(k)+2Δl tan γ(k) (5)
setting R(1)=0, then S(1)=V₁(1) and S(2)=V₂(1), so as to compute a recurrence formula:
S(k+2)=V₁(k)−2V₂(k)+V₃(k)−S(k)+2S(k+1) (6)
when considering the unevenness error caused by installation, then:
V₁(k)=S(k)+R(k) (7)
V₂(k)=S(k+Δl)+R(k)+Δl tan γ(k)+δ₁ (8)
V₃(k)=S(k+2Δl)+R(k)+2Δl tan γ(k)+δ₂ (9)
through an inductive method, the error term of S(k+2) is:
Δs(k+2)=−(k−1)(k+1)δ₁+½k(k+1)δ₂, k=1,2, . . . ,N (10)
step E: continuing to rotate the rotating index plate (1) after reading N groups of readings, and reading the (N+1)th group of data and the (N+2)th group of data to eliminate an initial error, wherein because the measured surface is a ring and
$$N = \frac{{360}^{∘}}{α} ,$$
the (N+1)th point coincides with the 1st point and the (N+2)th point coincides with the 2nd point; setting
a=S(N+2)−S(2), b=S(N+1)−S(1), (11)
computing the values of δ₁ and δ₂ as:
$${δ}_{1} = \frac{( N + 1 ) b - ( N - 1 ) a}{{N}^{2} + 1} , \\ {δ}_{2} = \frac{4 - 2 N}{{N}^{2} + 1} a + \frac{2 ( {N}^{2} + N - 1 ) b}{{N}^{3} + N} \qquad ( 12 )$$
computing and substituting δ₁ and δ₂ into formula (6) to obtain the value Δs(k+2) of the error term of S(k+2), so an error separation formula is:
S̅(k+2)=S(k+2)−Δs(k+2) (k=1,2, . . . ,N) (13).
